(19) United States
(12) Patent Application Publication
(10) Pub. No.: US 2006/0161543 A1
(43) Pub. Date: Jul. 20, 2006

(54) Systems and methods for providing search results based on linguistic analysis

(75) Inventors: Xiao Kang Feng, Nanjing City (CN); Sky Woo, San Francisco, CA (US)

Correspondence Address: CARR & FERRELL LLP, 2200 GENG ROAD, PALO ALTO, CA, 94303, US

(73) Assignee: Tiny Engine, Inc.

(21) Appl. No.: 11/099,356

(22) Filed: Apr. 4, 2005

Related U.S. Application Data
(60) Provisional application No. 60/645,135, filed on Jan. 19, 2005.

(51) Int. Cl. G06F 7/00; G06F 17/30

(52) U.S. Cl. 707/5

(57) ABSTRACT

A system and method providing search results based on linguistic analysis is provided. The method comprises receiving content from one or more documents associated with search parameters entered by a user. Language associated with the content based on linguistic parameters is then analyzed. A score is assigned to the content based on the analysis of the language. The content is then ordered by relevance to the user based on the assigned score.

### CROSS-REFERENCE TO RELATED APPLICATIONS

The present application claims the benefit and priority of U.S. provisional patent application Ser. No. 60/645,135, filed on Jan. 19, 2005 and entitled “Systems and Methods for Providing Search Results Based on Linguistic Analysis,” which is herein incorporated by reference.

### BACKGROUND OF THE INVENTION

1. Field of the Invention

The present invention relates generally to search results based on a user query, and more particularly systems and methods for providing search results based on linguistic analysis.

2. Description of Related Art

In today's world, and in a time often coined “the information age,” people frequently search for information using computing devices. Networks, such as the Internet, have made searching for information more simplified as compared to going to a library and searching through indexes to find articles or books, for example. Nowadays, a user may simply enter words into a website query box in order to find information related to the entered words. The website providing the query box uses a search engine to scrutinize thousands of documents on the Internet and return documents having the words, also known as keywords, entered by the user.

Search engines are widely utilized over networks for locating the information sought by the user. Conventionally, search engines employ keyword matching in order to return web page links to the user seeking data related to the entered keywords. Accordingly, when the search engine displays links to pertinent web pages to the user, the links are displayed in order of the web page with the most keywords.

Another popular process utilized by conventional search engines is page ranking. Page ranking returns web page links that have the keywords based on a number of web pages that point to the web pages with the keywords. In other words, if a “web page D” includes the keywords specified by the user and the web page D is linked to by web pages A through C, for instance, the web page D will be listed first among the web pages with the keywords entered by the user when results are displayed to the user. The theory is that the links pointing to the web page D are essentially votes for the web page D, and if most other web pages point to the web page D, web page D must be the most popular of the web pages. Thus, the user will likely find the web page D most valuable, and the web page D is listed first.

Disadvantageously, few of the results returned by conventional search engines are closely related to the information actually sought by the user. Often, this is because the keywords in the document from the results are presented in a context different from the context sought by the user. The keywords in the document from the results may be related to other subjects. Alternatively, the most popular web pages with the keywords may be popular for reasons unrelated to the keywords and/or topic, and so forth. Often, the myriad of words and phrases that are not keywords in the documents associated with the results returned to the user are ignored. Of the hundreds or thousands of links to supposedly related web pages returned to the user, frequently only a few of the links are pertinent.

Therefore, there is a need for a system and method for providing search results based on linguistic analysis.

### SUMMARY OF THE INVENTION

The present invention provides a system and method for providing search results based on linguistic analysis. Content from at least one document associated with search parameters entered by a user is received. The content may include one or more segments comprising the at least one document. The content may be provided by a commercial search engine or a computer based information source, retrieved by a linguistic analysis engine, or received from any other source.

Language associated with the content is then analyzed based on linguistic parameters. The linguistic parameters may be represented by one or more anchors.

A score is assigned to the content based on the analysis of the language. The score may be associated with the content for storage and/or retrieval. The score assigned to each of the one or more segments of the content may be averaged or mathematically computed in order to provide a score for each of the one or more documents. The linguistic scores may be represented by one or more anchors.

The content is then ordered by relevance based on the assigned score. The content may be returned as search results directly to the user, and/or via a commercial search engine or information retrieval system based on the order of the content.

Various embodiments for providing the search results based on the linguistic analysis are disclosed.

### BRIEF DESCRIPTION OF THE DRAWINGS

FIG. 1 illustrates an exemplary architecture for providing search results to a user based on linguistic analysis in accordance with some embodiments;

FIG. 2 illustrates an exemplary architecture for providing the linguistic analysis component as a plug-in to a search engine or information retrieval system in accordance with some embodiments;

FIG. 3 illustrates an exemplary flowchart showing a method for utilizing linguistic analysis and hypotext to return results to a user in response to a user query in accordance with some embodiments;

FIG. 4 illustrates an exemplary flowchart for a method of segmenting text and electronic documents in accordance with some embodiments;

FIG. 5 illustrates an exemplary schematic diagram for linguistic patterns within the scoring indexes in accordance with some embodiments;

FIG. 6 illustrates an exemplary schematic diagram for generating linguistic scores based on linguistic analysis of data related to anchors in accordance with some embodiments;

FIG. 7 illustrates an exemplary link graph voting method in accordance with some embodiments;

FIG. 8 illustrates an exemplary schematic diagram for a feedback mechanism for the linguistic analysis engine according to some embodiments; and

FIG. 9 illustrates an exemplary schematic diagram for a feedback mechanism for goal optimization according to some embodiments.

### DESCRIPTION OF EXEMPLARY EMBODIMENTS

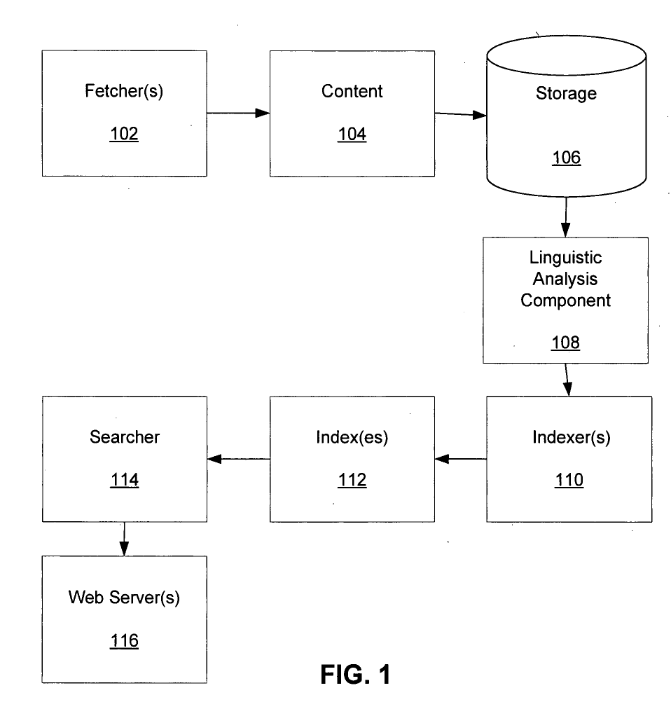

Referring to FIG. 1, an exemplary architecture for providing search results to a user based on linguistic analysis is shown. One or more fetchers 102 download web pages from various web sites. Content 104 from the web pages may be sent to storage 106. The content 104 may be compressed web pages, unique identifiers for locating the web pages, and so on. In some embodiments, additional servers may be provided for compressing the web pages, providing URLs for the web pages, and so forth.

A linguistic analysis component 108 retrieves the content 104 from the storage 106 and utilizes linguistic parameters to analyze the content 104. The linguistic analysis component 108 may separate the content 104 into segments, for example, and score each of the segments within the content 104 based on the linguistic parameters utilized. For instance, the linguistic analysis component 108 may separate a news story (i.e. the content 104) into segments according to paragraph structure and use optimism linguistic parameters to score individual paragraphs based on how optimistic the individual paragraphs are with respect to the language utilized in the individual paragraphs.

One or more indexers 110 parses the content 104. In the example of the segments of the news story broken down according to the individual paragraphs, the indexers 110 associate the segments of the news story with the scores of the individual segments. The indexers 110 can also associate an overall score provided by the linguistic analysis component 108 for the news story as a single document. In some embodiments, the indexers 110 decompress the content 104 if the content 104 was compressed before being forwarded to the storage 106. Additionally, the indexers 110 distribute the content 104 to one or more indexes 112.

A searcher 114, which is run by one or more web servers 116, matches search terms with the content 104 in the indexes 112. Results are then returned to a user presenting a query, via the one or more web servers 116, based on the matched search terms and the linguistic scores of the content 104. In some embodiments, the user may select the linguistic parameters, such as “readability”, for example, in which case the searcher 114 matches the search terms and the linguistic parameter specified by the user to the content 104 having a high score for readability and the search terms.

Various linguistic parameter options may be provided to the user, such as readability, optimism of the content 104, pessimism of the content 104, complexity, sarcasm, humor, rhetoric, political leaning, and so forth. Any linguistic parameters are within the scope of various embodiments.

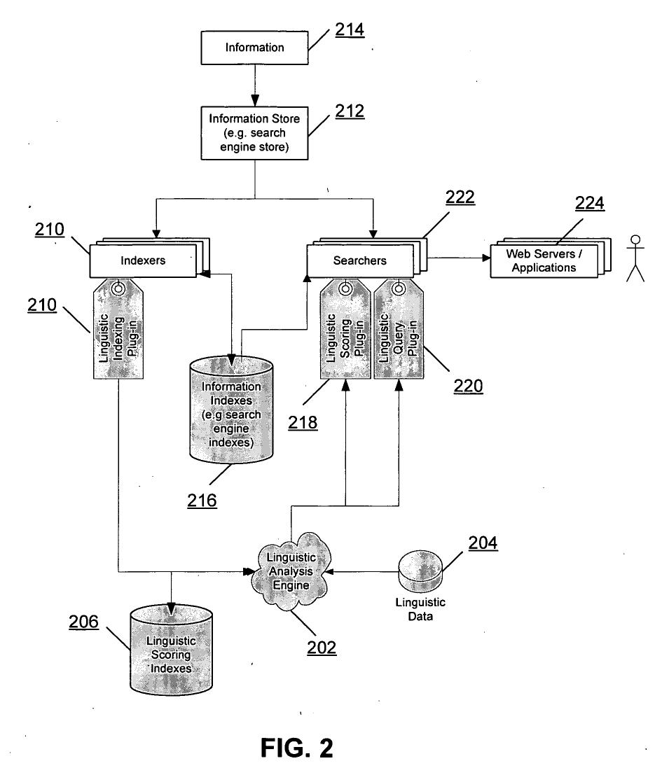

Turning now to FIG. 2, an exemplary architecture for providing the linguistic analysis component as a plug-in to a search engine or information retrieval system is shown. A linguistic analysis engine 202, such as the linguistic analysis component 108 described in FIG. 1, linguistic data from linguistic data storage 204. The linguistic data storage 204 may describe the linguistic analysis parameters for analyzing language in web page data and/or other data. The web page data and/or other data may be provided by a search engine or any other source. The linguistic analysis engine 202 assigns scores to the linguistic data from the linguistic data storage 204, organizes the linguistic data, and stores the linguistic data in linguistic scoring indexes 206.

The linguistic scoring indexes 206 can then be accessed by the linguistic analysis engine 202 to use when analyzing other data. A linguistic indexing plug-in 208 provides indexing parameters from the linguistic analysis engine 202 and linguistic scoring indexes 206 to indexers 210. The indexers 210 receive from an information store 212 various types of information 214. The information store 212 may include a search engine store or any other type of data store.

The indexers 210 organize the information 214 according to parameters from the linguistic indexing plug-in 208. In other words, the linguistic indexing plug-in 208 parameters may be utilized to apply linguistic scoring to the information 214. Once the information 214 has been indexed by the indexers 210 according to the linguistic parameter data, the information may be stored in information indexes 216. However, the indexers 210 may organize and store the information 214 in the information indexes 216 according to any method.

A linguistic scoring plug-in 218 and a linguistic query plug-in 220 may also utilize the linguistic scoring indexes 206 data. The linguistic scoring plug-in 218 may provide scoring related parameters to one or more searchers 222 to assist the searchers 222 with ranking data from the information indexes 216 and/or from the information store 212 according to linguistic parameters.

The linguistic query plug-in 220 may provide query parameters input by a user or other source to the searchers 222 to assist the searchers 222 with returning appropriate results based on the query parameters.

The searchers 222 present the results of an inquiry to the user via one or more web servers/applications 224. The web servers/applications 224 run the searchers 222. The searchers 222 utilize the information indexes 216 along with information from the linguistic scoring plug-in 218 and the linguistic query plug-in 220 to answer users' inquiries based on linguistic analysis of data from the information store 212 and the linguistic analysis engine 202.

Although certain architectures for providing the linguistic analysis engine 202 have been described, any type of architecture may be utilized for providing the linguistic analysis engine 202. For example, the linguistic analysis engine 202 may be installed on, or otherwise utilized in association with, for example, web servers linked to information, such as document databases, files, relational databases, electronic storage servers, index servers, etc. Further, third party products, such as statistical and mathematical programs, may be utilized in association with, or integrated with, the linguistic analysis solutions.

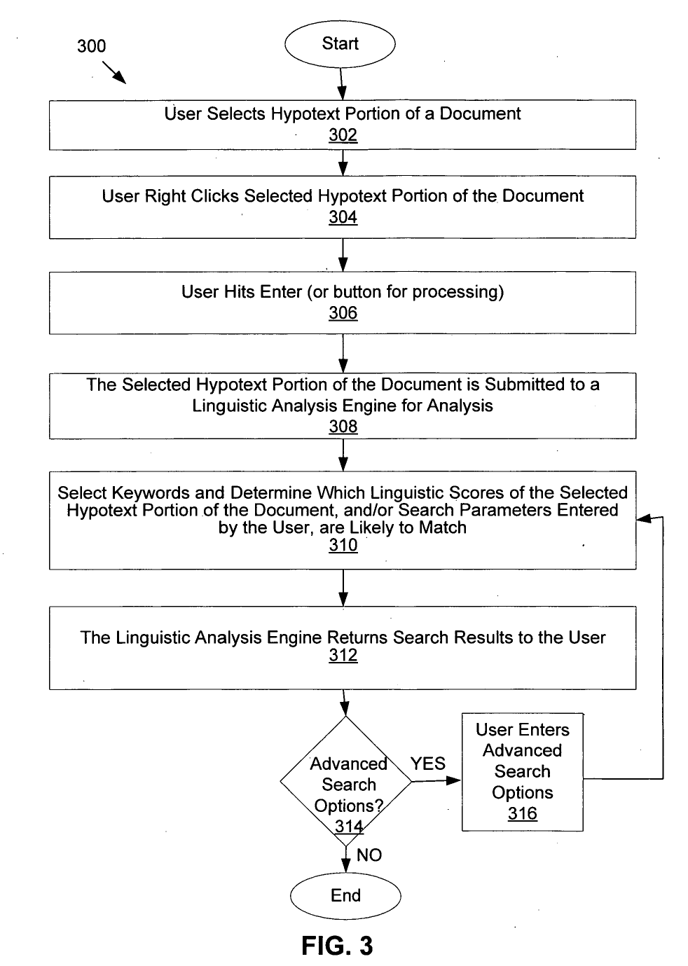

FIG. 3 is an exemplary flowchart 300 showing a method for utilizing linguistic analysis and hypotext to return results to a user in response to a user query. Hypotext includes words around keywords and/or hypertext links. A user selects a hypotext portion of a document at step 302. The document may be a hypertext document, for example. The user right clicks the selected hypotext portion of the document, at step 304. At step 306, the user hits enter, or any other button on a user interface for processing a request. The selected hypotext portion of the document is submitted to a linguistic analysis engine, such as the linguistic analysis component 108 described in FIG. 1 or the linguistic analysis engine 202 described in FIG. 2, for analysis at step 308.

At step 310, the linguistic analysis engine selects keywords from the selected hypotext portion of the document and/or from search parameters entered by the user, and determines which linguistic scores of the selected hypotext portion of the document are likely to match the context of the selected hypotext portion of the document.

The scores may be pre-generated and available via a scoring index, such as the linguistic scoring indexes 206 described in FIG. 2, or the scores may be generated following receipt of the user query. In order to determine the linguistic scores that most likely match the selected portion of the document, linguistic analysis parameters based on schematic, syntactic, and/or semantic and/or other natural language relationships of words and language dimensions of the words may be utilized.

For instance, if the linguistic analysis engine determines that the context of the selected portion of the document is good news about a particular medication, the linguistic analysis searches for other documents with high linguistic scores for good news about the particular medication. The linguistic analysis search engine may utilize any type of linguistic parameters, such as good news, bad news, readability, conflict, subject matter, variety, and so on.

At step 312, the linguistic analysis engine returns search results to the user based on the user selected portion of the document and the linguistic analysis of the selected portion. Optionally, at step 314, the user is presented with advanced search options.

If the user elects to utilize the advanced search options, the user may enter the advanced search options at step 316, and/or be directed to another page for entering advanced search options. The linguistic analysis engine can then repeat the process of determining which documents best match the context of the advanced search options and/or any other information provided by the user. As discussed herein, although the example in the flowchart of FIG. 3 describes a linguistic analysis engine search based on the user's selection of the hypotext portion of the document, the linguistic analysis engine search may also, or instead, be based on search parameters entered by the user. Any search performed by the linguistic analysis engine and/or any linguistic analysis performed by the linguistic analysis engine based on other search results is within the scope of various embodiments.

Although hypotext has been exemplified in FIG. 3, any type of linguistic parameters may be utilized. Further, any method for accepting linguistic parameters may be employed. For instance, the user may enter keywords into a box, select popular linguistic parameters from a drop down menu, and so forth.

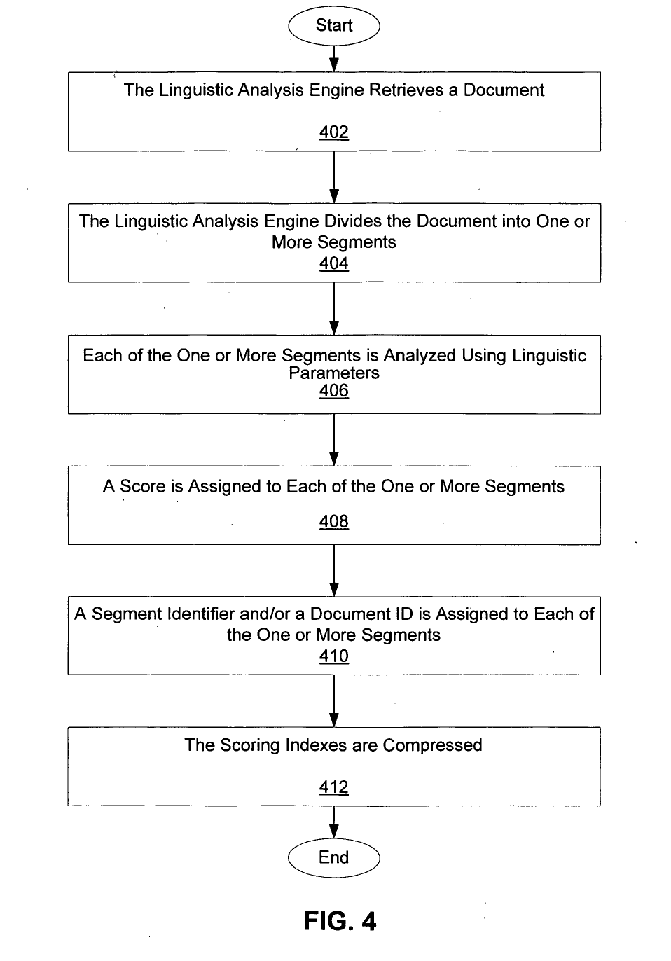

In FIG. 4, an exemplary flowchart 400 for a method of segmenting text and electronic documents is shown. The linguistic analysis engine retrieves a document at step 402. As discussed herein, the document may be a web page, a portion of the contents of the web page, and so forth. At step 404, the linguistic analysis engine separates the document into one or more segments and/or assigns the document, in its entirety to a segment identifier. Each of the one or more segments is analyzed using linguistic parameters at step 406. If the document is assigned only one segment identifier, the entire document is analyzed as a single segment using the linguistic parameters, unless the segment identifier is only assigned to a segment of the document that is not the entire document.

At step 408, a score is assigned to each of the one or more segments according to the linguistic parameters utilized, search parameters in a query entered by a user, search parameters provided by a search engine or information retrieval system, and so forth. In other words, the score is based on the words in the document according to a context, the context determined by the search parameters entered and/or the hypotext provided. Each of the one or more segments is assigned a segment identifier (“ID”) and/or a document ID for indexing the segments in a scoring index at step 410. The scoring indexes are compressed at step 412.

When the linguistic analysis engine needs to locate the document, or segment of the document, based on a query, the linguistic analysis engine searches the scoring indexes for retrieval of information that matches the search parameters and the linguistic parameters. The result is then returned to the user presenting the query. As discussed herein, the individual segments of the documents may be returned to the user, as pertinent to the query. Alternatively, two or more of the individual segments of the document may be combined to approximate a score within the area covered by the two or more segments.

For example, segment A of document #1 may include 250 word tokens. Each word token represents a word, the words possibly being varying lengths. The segment A of the document #1 is compressed in order to be represented by one score and/or one ID associated with the score. Thus, the linguistic analysis engine may quickly retrieve the segment A and the score of the segment A. The segment A may be returned to the user as text pertinent to the user's query. The linguistic analysis engine, however, may approximate the scores of the segment A and segment B of the document #1 by averaging the scores of the different linguistic parameters for each of the segment A and the segment B. The language of the segment A and the segment B is returned to the user as text pertinent to the user's query based on the approximated score by the linguistic analysis engine. Any number of segments, combination of the segment scores, approximation of the segment scores, and so on may be used to locate data pertinent to the user's query in various embodiments. Further, any method of combining the scores may be utilized according to various embodiments.

The linguistic analysis engine may also search for the segments of the documents by linguistic scoring patterns. For instance, if the linguistic analysis engine requires documents or segments of documents with higher levels of conflict in document text and a higher usage of imagery for expressing ideas, the linguistic analysis engine can search for the documents and/or the segments within the documents that are scored high for the linguistic parameters “imagery” and “conflict.” A visual or textual representation system, such as a color coding system, may be employed for identifying segments with high scores for various linguistic parameters. As discussed herein, linguistic parameters may represent various contexts, subject matter, and so on. For instance, red circles may indicate high scores for the linguistic parameters, while light shading represents moderate scores, and no shading represents low scores for the linguistic parameters.

In some embodiments, the linguistic analysis engine retrieves only the segments from the documents with the desired scores for the linguistic parameters related to a query, rather than the entire documents, themselves. The segments retrieved by the linguistic analysis engine may be presented to the user as a series of citations. Alternatively, the segments retrieved by the linguistic analysis engine may be combined together and presented to the user as a summary document.

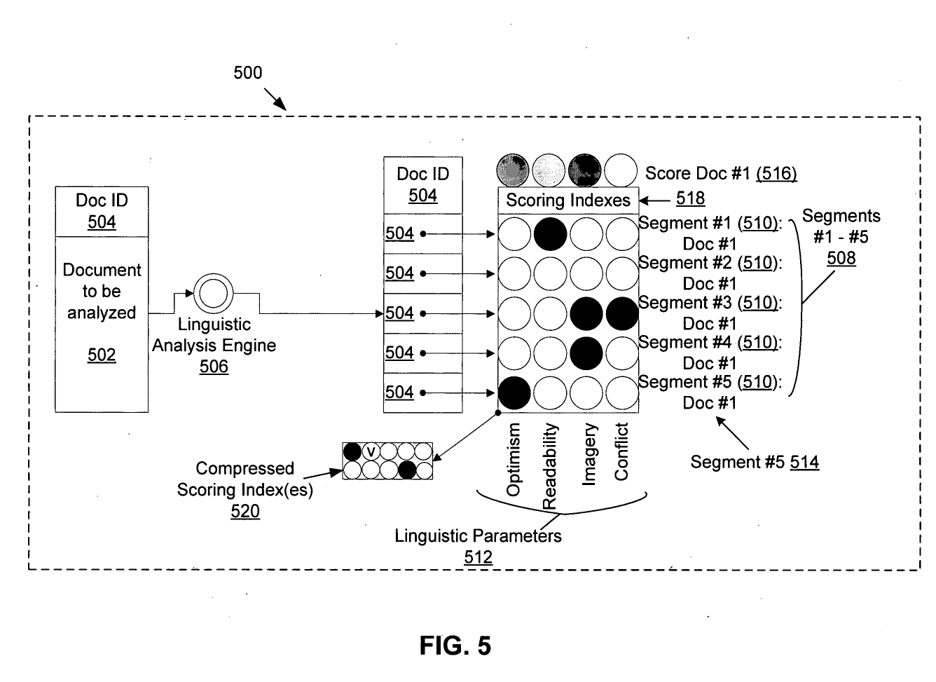

Referring now to FIG. 5, an exemplary schematic diagram 500 for linguistic patterns within the scoring indexes, such as the indexes 112 in FIG. 1 and/or the linguistic analysis ranking indexes 226 in FIG. 2, is shown. A document 502, such as the content 104 described in FIG. 1 or any other content, is provided for analysis. The document 502 may include a document ID 504 for identifying the document 502. The document 502 is retrieved by, or sent to, a linguistic analysis engine 506, such as the linguistic analysis component 108 in FIG. 1. The linguistic analysis engine 506, in this exemplary schematic diagram, divides the document 502 into segments #1 through #5 508. Each of the segments #1-#5 is assigned the document ID 504 associated with the document 502, as well as a unique segment identifier 510. Alternatively, the segments #1-#5 508 may each be assigned a unique identifier without the document ID 504. In some embodiments, information in headers associated with the segments #1-#5 508, or elsewhere in the segments #1-#5 508, may associate each of the segments #1-#5 508 with the document 502. Scores for linguistic parameters 512 are assigned by the linguistic analysis engine 506. The linguistic parameters 512 in this exemplary schematic diagram are “optimism”, “readability”, “imagery”, and “conflict.” Alternative embodiments may utilize other linguistic parameters 512. As discussed herein, a color coding system, or any other system, may be employed for indicating the hierarchy of the score for each of the segments #1-#5 508.

Each of the segments #1-#5 508 is scored according to the linguistic parameters 512. For instance, the segment #5 514 of the segments #1-#5 508 of the document 502 scored highly for the linguistic parameter 512 referred to as optimism, but low for the linguistic parameters 512 referred to as readability, imagery, and conflict. Thus, if the user query indicates a desire for subject matter that is optimistic, the segment #5 514 may be returned as the result, or part of the results, to the user. The scores for the segments #1-#5 508 may be combined to generate a document score 516 for the document 502 as a whole.

Each of the segments #1-#5 508 along with their scores assigned for the linguistic parameters 512 are stored in scoring indexes 518. The scoring indexes 518 can also store the document score 516 for the document 502. In some embodiments, the scoring indexes 518 are stored as a compressed scoring index(es) 520. The compressed scoring index 520 can be searched and the document 502 and/or the segments #1-#5 508 retrieved in a compressed format. The search and retrieval of the compressed scoring index 520 may be based on linguistic patterns. Thus, the linguistic analysis engine 506, or any other search engine, can search for segments and/or documents that match a user query and the linguistic parameters 512, as discussed herein. In the example discussed herein, if the linguistic parameter 512 desired is optimism, the segment #5 514 may be retrieved by extracting segments and/or documents having a high optimism linguistic pattern in order to respond to the user query. Any type of linguistic pattern may be searched for, including linguistic patterns that include high scores for more than one of the linguistic parameters 512, low scores for more than one of the linguistic parameters 512, varying scores for the linguistic parameters 512, no more than one low score for a specified linguistic parameter, and so on.

Although the linguistic analysis engine 506 is described as performing indexing functions in FIG. 5, an indexer, such as the indexer(s) 110 described in FIG. 1, may be utilized for indexing functions.

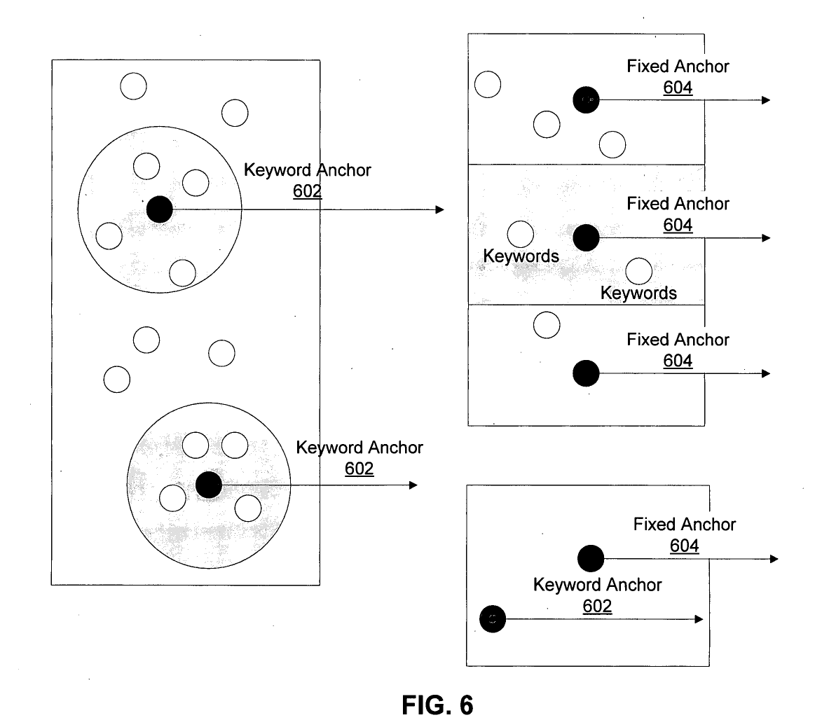

Turning now to FIG. 6, an exemplary schematic diagram for generating linguistic scores based on linguistic analysis of anchors is shown. An anchor can be any location in a document or a segment that defines a word or word token position. Keyword anchors 602 are shown in a grouping of keywords. The keyword anchors 602 are located near heavier concentrations of keyword occurrences. The keyword anchors 602 may be obtained via analyzing indexes and storage associated with a search engine. Priority may be assigned to the keyword anchors 602 with the highest density of the keywords around the keyword anchor 602 and/or the biggest variety of the keywords around the keyword anchor 602. However, any manner of designating the keyword anchors 602 may be utilized in accordance with some embodiments. For instance, the keyword anchors 602 may be chosen randomly in order to provide sampling locations within the document or the segment.

Fixed anchors 604 mark a single location within the segment. Document anchors (not shown) mark the beginning and end of the document. A score for the document as a whole may be associated with the document anchors. The document anchors, the keyword anchors 602, and the fixed anchors 604, as well as ranges around the anchors, may be compared to one another to help align and score the segments of the document. The fixed anchor 604 may have an associated linguistic score or any other type of score. The fixed anchor 604 and the fixed anchor 604 score may be indexed in a scoring index, such as the scoring indexes 518 discussed in FIG. 5. Each of the segments has a fixed anchor, such as the fixed anchor 604 discussed in FIG. 6, that indicates the segment's location within the document, a range around the fixed anchor, and linguistic scores associated with the segment marked by the fixed anchor.

When a query begins, documents are returned by a search engine or the linguistic analysis engine. The documents are chosen by the search engine based on keyword frequency and/or popularity of the documents based on other documents that link to the documents, or by any other search engine recipe for returning documents or URLs to a user. The linguistic analysis engine may utilize the documents returned by the search engine to return scores for the documents or scores for the segments within each of the documents to the search engine. An administrator or other user for the search engine determines how the document and/or the segment scores from the linguistic analysis engine will be utilized when returning results to a user presenting the query. For example, the administrator for the search engine may decide to present the documents and/or the segments to the user in the order according to the linguistic scores for the documents and/or the segments, according to an average of the order dictated by the search engine results and the order dictated by the linguistic scores, and so forth. As discussed herein, the linguistic analysis engine may return results directly to the user based on the search parameters of the user query and the linguistic scores of the documents retrieved by the linguistic analysis engine, the search engine, and/or the segments.

The scores for the documents may include an overall score assigned by the linguistic analysis engine for each of the documents and/or an average of scores of each of the segments within each of the documents. The scores for each of the segments within the document may be returned as individual segments in an order according to the respective linguistic scores for each of the segments and/or a summary page may be returned with one or more of each of the segments with an averaged score based on the segments returned in the summary.

For linguistic scores assigned to each of the segments within the documents, the linguistic analysis engine matches the keyword anchors 602 related to the query to the fixed anchors 604 for each of the segments. The linguistic scores associated with the fixed anchors 604 that are closest to the keyword anchors 602 related to the query are retrieved and returned, utilized to create a summary, and/or utilized as part of the document score. If the search engine is utilized to return the results to the user, rather than the linguistic analysis engine returning the results directly to the user, the linguistic analysis engine returns an ordered list of the documents to the search engine ranked according to the linguistic scores of each of the segments within the documents and/or the documents, themselves.

In some embodiments, precision anchors (not shown) may be utilized to measure the number of words, or word tokens as discussed herein, in the immediate vicinity of the keyword anchors 602. The precision anchors may utilize a range so that the number of words around the keyword anchors 602 can be measured as well as a measurement of the closeness of the keyword anchors 602 to the precision anchors.

A system administrator, or other user, may specify the number of the keyword anchors 602, the fixed anchors 604, and/or the precision anchors that may be assigned within the documents and/or the segments within the documents. A maximum and/or a minimum number may be specified for each of the anchors. Each of the anchors may have the same maximum and/or minimum number or different maximum and/or minimum numbers. In some embodiments, default numbers are specified for each of the anchors for searches. The user may affect the default numbers via the user interface.

Numbers of occurrences within the documents or the segments within the documents of each of the anchors may be specified according to the particular linguistic parameters being applied. For instance, for the linguistic parameter 512 (FIG. 5) referred to as readability, the default number of fixed anchors in the document may be set at a maximum number. The maximum number may be any number fewer than the total word tokens comprising a particular document, a series of documents, and/or each of the segments within the particular document and/or the series of documents. The linguistic scores discussed herein may be represented by one or more anchors.

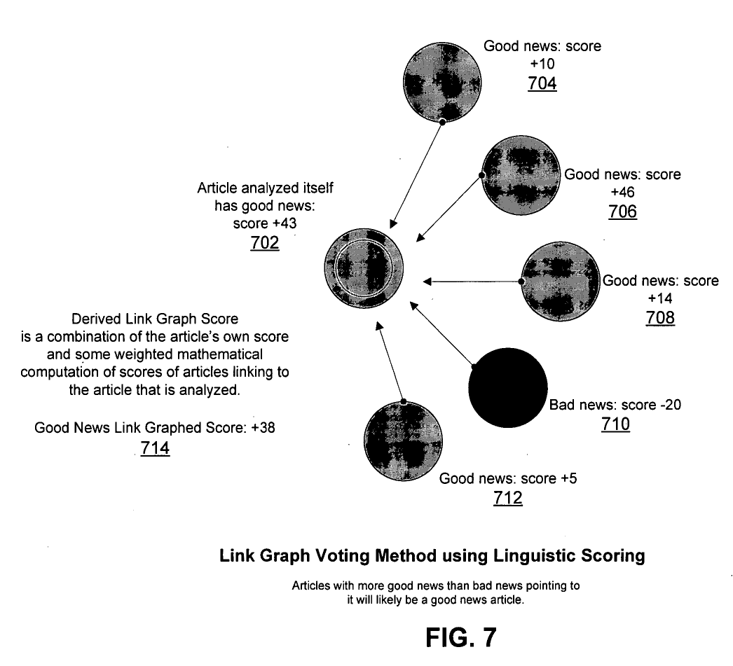

In some embodiments, a link graph voting method using linguistic scoring may be employed. Turning now to FIG. 7, an illustration of an exemplary link graph voting method is shown in accordance with some embodiments. The link graph voting method may take into account scores of various documents and/or segments of the documents when scoring a particular document and/or segments of the particular document. For instance, an article 702 that analyzed itself may have a good news score of 43, as shown using the linguistic parameter 512 (FIG. 5) “good news.” Other documents may be referenced in order to adjust the good news score for the article 702. A good news score +10 document 704 may be combined with good news score +46 document 706, good news score +14 document 708, bad news score −20 document 710, and good news score +5 document 712, as shown in FIG. 7. The good news scores of the documents 704-712 are combined with the good news score from the article 702 using an average or weighted mathematical computation, and a good news link graph score may be provided based on the combination. The good news link graphed score is +38 714 in FIG. 7. As discussed herein, any manner of combining the good news scores may be utilized, such as a simple method, a propagating method, and so on.

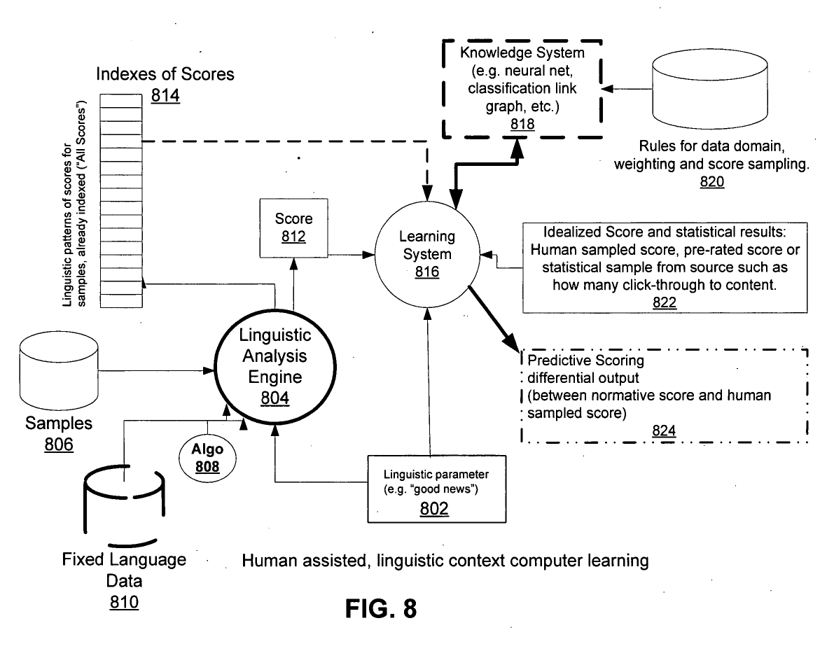

Turning now to FIG. 8, an exemplary schematic diagram for a feedback mechanism for the linguistic analysis engine according to some embodiments is shown. Linguistic parameters 802 are submitted to the linguistic analysis engine 804, such as the linguistic analysis component 108 and/or the linguistic analysis engine 202 described in FIGS. 1 and 2, respectively. Text samples 806 are scored at the linguistic analysis engine 804 using fixed language data 810 and/or algorithms 808. Any type of fixed language data 810 and/or algorithms 808 may be utilized. Further, any source may provide the fixed language data 810.

The linguistic analysis engine 804 also produces scores 812 and indexes the scores 814. The scores 812 are then provided to a learning system 816. The learning system 816 collects data from human sampled scores, pre-rated scores, and/or statistical samples 822 from various sources, for analysis.

The learning system 816 uses the scores 812, the linguistic parameters 802, and indexed patterns of scores from the indexes of scores 814 associated with the samples 806 of text to discover contextual linguistic patterns of data that may be modeled into a knowledge system 818. The knowledge system 818 may utilize advanced artificial intelligence, classification, link graph systems, and/or other mathematical models.

When the learning system 816 encounters a standardized normative score from the linguistic analysis engine 804 in the future, the learning system 816 can use linguistic patterns of scores to predict the expected variation of the normative score to the idealized score, or predictive scoring 824. The learning system 816 can train itself according to stored rules 820 for data domain, weighting, score sampling, and so forth. The context of other linguistic scores for text, therefore, create a multi-layer feedback to predict an idealized score.

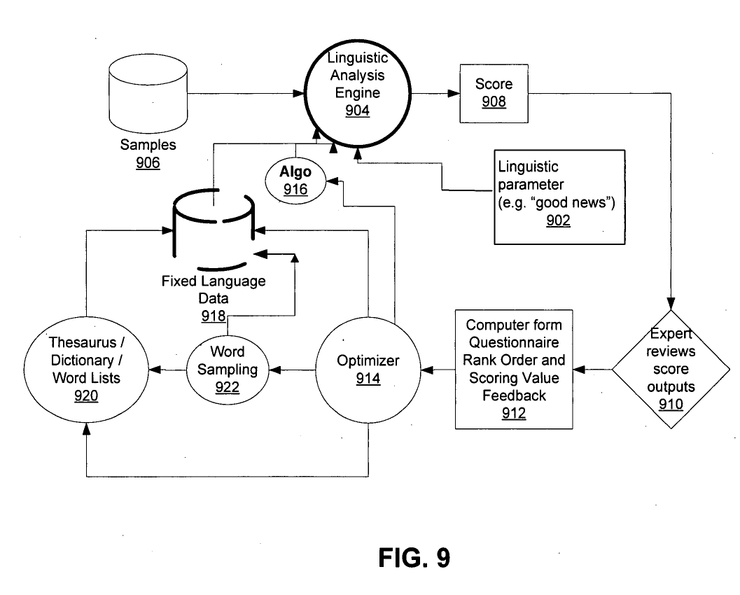

Turning now to FIG. 9, an exemplary schematic diagram for a feedback mechanism for goal optimization according to some embodiments is shown. Linguistic parameters 902, such as “good news”, are submitted to the linguistic analysis engine 904. Samples 906, such as sample texts, are also submitted to the linguistic analysis engine 904. The linguistic analysis engine 904 assigns a score 908 to the samples 906.

The scores 908, and/or any other results provided by the linguistic analysis engine 904, are reviewed by experts 910, administrators, or a high quality user polling. The expert reviews of score outputs 910 may include computer form questionnaires or some type of statistical analysis (i.e., polled information). The computer form questionnaires, rank order, and scoring value feedback 912 is provided to an optimizer 914.

The optimizer 914 utilizes this polled information as goals for an optimizer system associated with the linguistic analysis engine 904. The optimizer 914 may adjust parameters associated with algorithms 916 and/or fixed language data 918. Fixed language data may include a schema dictionary, words, weights, or any other data.

The optimizer 914 may also utilize a thesaurus, dictionaries, and/or word lists 920. Word samplings 922, such as statistical samplings of word data to modify the fixed language data 918, may also be utilized by the optimizer 914. Accordingly, the fixed language data 918 and/or the algorithms 914 for linguistic analysis of documents, search engine results, and so on may help the linguistic analysis engine 904 in providing improved results.

While various embodiments have been described above, it should be understood that they have been presented by way of example only, and not limitation. For example, any of the elements may employ any of the desired functionality set forth hereinabove. Thus, the breadth and scope of a preferred embodiment should not be limited by any of the above-described exemplary embodiments.

What is claimed is:

1. A method for providing search results based on linguistic analysis comprising:
receiving content from one or more documents associated with search parameters entered by a user;
analyzing language associated with the content based on linguistic parameters;
assigning a score to the content based on the analysis of the language; and
ordering the content by relevance to the user based on the assigned score.

2. The method as recited in claim 1, wherein the content comprises one or more segments comprising the one or more documents.

3. The method as recited in claim 2, further comprising averaging the scores of the one or more segments in order to provide a score for each of the one or more documents.

4. The method as recited in claim 1, further comprising presenting the search results to the user based on the order of the content.

5. The method as recited in claim 1, further comprising forwarding the content to a commercial search engine that presents the search results to the user based on the order of the content.

6. The method as recited in claim 1, further comprising associating the content with the assigned score for storage.

7. The method as recited in claim 1, wherein the linguistic parameters are represented by anchors.

8. A computer program embodied on a computer readable medium for providing search results based on linguistic analysis, comprising instructions for:
receiving content from one or more documents associated with search parameters entered by a user;
analyzing language associated with the content based on linguistic parameters;
assigning a score to the content based on the analysis of the language; and
ordering the content by relevance to the user based on the assigned score.

9. The computer program as recited in claim 8, wherein the content comprises one or more segments comprising the one or more documents.

10. The computer program as recited in claim 9, further comprising averaging the scores of the one or more segments in order to provide a score for each of the one or more documents.

11. The method as recited in claim 8, further comprising presenting the search results to the user based on the order of the content.

12. The computer program as recited in claim 8, further comprising forwarding the content to a commercial search engine that presents the search results to the user based on the order of the content.

13. The computer program as recited in claim 8, further comprising associating the content with the assigned score for storage.

14. The computer program as recited in claim 8, wherein the linguistic parameters are represented by anchors.

15. An system for providing search results based on linguistic analysis comprising:
an index for receiving content from one or more documents associated with search parameters entered by a user;
a linguistic analysis component for analyzing language associated with the content based on linguistic parameters, for assigning a score to the content based on the analysis of the language, and for ordering the content by relevance to the user based on the assigned score; and
a web server for presenting results to the user based on the search parameters.

16. The system as recited in claim 15, wherein the content comprises one or more segments comprising the one or more documents.

17. The system as recited in claim 15, further comprising averaging the scores of the one or more segments in order to provide a score for each of the one or more documents.

18. The system as recited in claim 15, further comprising forwarding the content to a commercial search engine that presents the search results to the user based on the order of the content.

19. The system as recited in claim 15, further comprising associating the content with the assigned score for storage.

20. The system as recited in claim 15, wherein the linguistic parameters are represented by anchors.
